(19) United States
(12) Patent Application Publication
(10) Pub. No.: US 2005/0100181 A1
(43) Pub. Date: May 12, 2005

(54) Parametric transducer having an emitter film

(75) Inventors: James J. Croft III, San Diego, CA (US); Mark Norris, Poway, CA (US); Norbert Daberko, Encinitas, CA (US)

Correspondence Address: THORPE NORTH & WESTERN, LLP., 8180 SOUTH 700 EAST, SUITE 200, P.O. BOX 1219, SANDY, UT, 84070, US

(73) Assignees: Particle Measuring Systems, Inc., Boulder, CO (US); American Technology Corporation

(21) Appl. No.: 10/923,295

(22) Filed: Aug. 20, 2004

Related U.S. Application Data
(63) Continuation-in-part of application No. 09/787,972, filed on Jan. 17, 2002.
(63) Continuation-in-part of application No. 09/159,442, filed on Sep. 24, 1998.
(63) Continuation-in-part of application No. 09/478,114, filed on Jan. 4, 2000.
(60) Provisional application No. 60/496,834, filed on Aug. 21, 2003.

(51) Int. Cl. H04R 3/00

(52) U.S. Cl. 381/190

(57) ABSTRACT

A parametric transducer which includes a support member extending along an x-axis and a y-axis and having opposing front and back surfaces. The support member includes an array of parallel ridges extending along the x-axis and spaced apart along the y-axis at predetermined separation distances. The ridges have forward, film contacting faces to support an emitter film in a desired film configuration for emitting parametric output. An electrically sensitive and mechanically responsive (ESMR) film is disposed over the support member with one side of the ESMR film being captured by the film contacting faces, and with arcuate sections aligned with and positioned between the parallel ridges. The film contacting faces mechanically isolate each of the arcuate sections of ESMR film from adjacent arcuate sections.

Priority of application No. 60/496,834 filed Aug. 21, 2003 in the United States Patent Office is hereby claimed.

### PRIOR APPLICATION

This application is a continuation-in-part of Ser. No. 09/787,972 filed Jan. 17, 2002, and of Ser. No. 09/159,442 filed Sep. 24, 1998, and of Ser. No. 09/478,114 filed Jan. 4, 2000. The above disclosures are hereby incorporated herein by reference. The method for constructing the disclosed parametric transducer is included in co-pending application entitled Method For Constructing A Parametric Transducer Having An Emitter Film.

### BACKGROUND OF THE INVENTION

1. Field of the Invention

The present invention relates generally to the field of parametric loudspeakers. More particularly, the present invention relates to the use of a piezoelectric film as an emitter on an ultrasonic parametric transducer.

2. Related Art

Audio reproduction has long been considered a well-developed technology. Over the decades, sound reproduction devices have moved from a mechanical needle on a tube or vinyl disk, to analog and digital reproduction over laser and many other forms of electronic media. Advanced computers and software now allow complex programming of signal processing and manipulation of synthesized sounds to create new dimensions of listening experience, including applications within movie and home theater systems. Computer generated audio is reaching new heights, creating sounds that are no longer limited to reality, but extend into the creative realms of imagination.

Nevertheless, the actual reproduction of sound at the interface of electromechanical speakers with the air has remained substantially the same in principle for almost one hundred years. Such speaker technology is clearly dominated by dynamic speakers, which constitute more than 90 percent of commercial speakers in use today. Indeed, the general class of audio reproduction devices referred to as dynamic speakers began with the simple combination of a magnet, voice coil and cone, driven by an electronic signal. The magnet and voice coil convert the variable voltage of the signal to mechanical displacement, representing a first stage within the dynamic speaker as a conventional multistage transducer. The attached cone provides a second stage of impedance matching between the electrical transducer and air envelope surrounding the transducer, enabling transmission of small vibrations of the voice coil to emerge as expansive compression waves that can fill an auditorium. Such multistage systems comprise the current fundamental approach to reproduction of sound, particularly at high energy levels.

A lesser category of speakers, referred to generally as film or diaphragmatic transducers, relies on movement of an emitter surface area of film that is typically generated by electrostatic or planar magnetic driver members. Although electrostatic speakers have been an integral part of the audio community for many decades, their popularity has been quite limited. Typically, such film emitters are known to be low-power output devices having applications appropriate only to small rooms or confined spaces. With a few exceptions, commercial film transducers have found primary acceptance as tweeters and other high frequency devices in which the width of the film emitter is equal to or less than the propagated wavelength of sound. Attempts to apply larger film devices have resulted in poor matching of resonant frequencies of the emitter with sound output, as well as a myriad of mechanical control problems such as maintenance of uniform spacing from the stator or driver, uniform application of electromotive fields, phase matching, frequency equalization, etc.

As with many well-developed technologies, advances in the state of the art of sound reproduction have generally been limited to minor enhancements and improvements within the basic fields of dynamic and electrostatic systems. Indeed, substantially all of these improvements operate within the same fundamental principles that have formed the basics of well-known audio reproduction. These include the concept that (i) sound is generated at a speaker face, (ii) based on reciprocating movement of a transducer (iii) at frequencies that directly stimulate the air into the desired audio vibrations. From this basic concept stems the myriad of speaker solutions addressing innumerable problems relating to the challenge of optimizing the transfer of energy from a dense speaker mass to the almost massless air medium that must propagate the sound.

A second fundamental principle common to prior art dynamic and electrostatic transducers is the fact that sound reproduction is based on a linear mode of operation. In other words, the physics of conventional sound generation rely on mathematics that conform to linear relationships between absorbed energy and the resulting wave propagation in the air medium. Such characteristics enable predictable processing of audio signals, with an expectation that a given energy input applied to a circuit or signal will yield a corresponding, proportional output when propagated as a sound wave from the transducer.

In such conventional systems, maintaining the air medium in a linear mode is extremely important. If the air is driven excessively into a nonlinear state, severe distortion occurs and the audio system is essentially unacceptable. This nonlinearity occurs when the air molecules adjacent the dynamic speaker cone or emitter diaphragm surface are driven to excessive energy levels that exceed the ability of the air molecules to respond in a corresponding manner to speaker movement. In simple terms, when the air molecules are unable to match the movement of the speaker so that the speaker is loading the air with more energy than the air can dissipate in a linear mode, then a nonlinear response occurs, leading to severe distortion and speaker inoperability. Conventional sound systems are therefore built to avoid this limitation, ensuring that the speaker transducer operates strictly within a linear range.

Parametric sound systems, however, represent an anomaly in audio sound generation. Instead of operating within the conventional linear mode, parametric sound can only be generated when the air medium is driven into a nonlinear state. Within this unique realm of operation, audio sound is not propagated from the speaker or transducer element. Instead, the transducer is used to propagate carrier waves of high-energy, ultrasonic bandwidth beyond human hearing. The ultrasonic wave therefore functions as the carrier wave, which can be modulated with audio input that develops sideband characteristics capable of decoupling in air when driven to the nonlinear condition. In this manner, it is the air molecules and not the speaker transducer that will generate the audio component of a parametric system. Specifically, it is the sideband component of the ultrasonic carrier wave that energizes the air molecule with audio signal, enabling eventual wave propagation at audio frequencies.

Another fundamental distinction of a parametric speaker system from that of conventional audio is that high-energy transducers as characterized in prior art audio systems do not appear to provide the necessary energy required for effective parametric speaker operation. For example, the dominant dynamic speaker category of conventional audio systems is well known for its high-energy output. Clearly, the capability of a cone/magnet transducer to transfer high-energy levels to surrounding air is evident from the fact that virtually all high-power audio speaker systems currently in use rely on dynamic speaker devices. In contrast, low output devices such as electrostatic and other diaphragm transducers are virtually unacceptable for high-power requirements. As an obvious example, consider the outdoor audio systems that service large concerts at stadiums and other outdoor venues. Normally, massive dynamic speakers are necessary to develop direct audio to such audiences. To suggest that a low-power film diaphragm might be applied in this setting would be considered foolish and impractical.

Yet in parametric sound production, the present inventors have surprisingly discovered that a film emitter will outperform a dynamic speaker in developing high-power, parametric audio output. Indeed, it has been the general experience of the present inventors that efforts to apply conventional audio practices to parametric devices will typically yield unsatisfactory results. This has been demonstrated in attempts to obtain high sound pressure levels, as well as minimal distortion, using conventional audio techniques. It may well be that this prior art tendency of applying conventional audio design to construction of parametric sound systems has frustrated and delayed the successful realization of commercial parametric sound. This is evidenced by the fact that prior art patents on parametric sound systems have utilized high-energy, multistage-like bimorph transducers comparable to conventional dynamic speakers. Despite widespread, international studies in this area, none of these parametric speakers were able to perform in an acceptable manner.

In summary, whereas conventional audio systems rely on well accepted acoustic principles of (i) generating audio waves at the face of the speaker transducer, (ii) based on a high-energy output device such as a dynamic speaker, (iii) while operating in a linear mode, the present inventors have discovered that just the opposite design criteria are preferred for parametric applications. Specifically, effective parametric sound is effectively generated using (i) a comparatively low-energy film diaphragm, (ii) in a nonlinear mode, (iii) to propagate an ultrasonic carrier wave with a modulated sideband component that is decoupled in air (iv) at extended distances from the face of the transducer. In view of these distinctions, it is not surprising that much of the conventional wisdom developed over decades of research in conventional audio technology is simply inapplicable to problems associated with the generation parametric sound.

One specific area of transducer design that illustrates the uniqueness of parametric emitter design compared to conventional audio transducers is the adaptation of a film emitter to generate ultrasonic output at sufficient energy levels to drive air at the required nonlinear condition. As indicated above, film emitters are known to be low-energy devices. Nevertheless, film emitters have now been developed for parametric transducers as disclosed in the parent patent applications. Such emitter design has generally been characterized as an array of small emitter sections disposed across a monolithic film diaphragm. The following disclosure provides further enhancements to the development of an effective film emitter capable of generating high-power output, despite the traditional view that film emitters were limited to low-power applications.

### SUMMARY OF THE INVENTION

It has been determined that it would be advantageous to develop a parametric speaker system, which uses a piezoelectric film as an emitter, where the film may be applied without being sustained by positive or negative pressure supplied by a vacuum or some other device.

The invention provides a parametric transducer which includes a support member extending along an x-axis and a y-axis and having opposing front and back surfaces. The support member includes an array of parallel ridge locations extending along the x-axis and spaced apart along the y-axis at predetermined separation distances. The ridge locations have forward, film contacting faces to support an emitter film in a desired film configuration for emitting parametric output. An electrically sensitive and mechanically responsive (ESMR) film is disposed over the support member with one side of the ESMR film being captured by the film contacting faces, and with arcuate sections disposed between the parallel ridges. The film contacting faces mechanically isolate each of the arcuate sections of ESMR film from adjacent arcuate sections.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

The following drawings illustrate exemplary embodiments for carrying out the invention. Like reference numerals refer to like parts in different views or embodiments of the present invention in the drawings.

FIG. 1a is a perspective bottom view of a support member, in accordance with an embodiment of the present invention;

FIG. 1b is a perspective view of an ultrasonic, parametric transducer, including a support member and a piezoelectric type film to be applied to the support member, in accordance with an embodiment of the present invention;

FIG. 2a is a perspective view of the transducer of FIG. 1, wherein the film has been applied to the support member;

FIG. 2b is a perspective view of a transducer, wherein the support member has a front surface in a smooth continuous configuration, in accordance with an embodiment of the present invention;

FIG. 2c is a perspective view of a transducer, wherein the support member configures the film to have a concave dish curvature for focusing a propagated wave;

FIG. 2d is a perspective view of a transducer, wherein the support member configures the film to have a convex dish curvature for dispersing a propagated wave;

FIG. 3 is an enlarged perspective view of a channel cross section, to illustrate some of the critical dimensions of the transducer;

FIG. 4 is a perspective view of a transducer, including a support member having channel cross sections configured with a concave curvature, in accordance with an embodiment of the present invention;

FIG. 5 is a perspective view of a transducer, wherein the film contacting faces of the support member include a convex curvature with respect to the front surface, in accordance with an embodiment of the present invention;

FIG. 6a is a perspective view of a transducer, wherein the film is configured in the form of alternating concave and convex arcuate sections, in accordance with an embodiment of the present invention;

FIG. 6b is a perspective view of a transducer, wherein the film is configured with arcuate sections protruding away from the support member;

FIG. 7a is a representation of multiple electrically isolated conductive portions of film being driven by multiple parametric signals created by providing a passive delay line;

FIG. 7b is a representation of a transducer having multiple electrically isolated conductive portions of film in a progressively larger ring configuration;

FIG. 7c is a representation of one method for connecting electrical contacts to the transducer in FIG. 7b;

FIG. 7d is a representation of one method for connecting electrical contacts to the transducer in FIG. 7b; and

FIG. 8 is a cross-sectional view of a parametric speaker, wherein the film is coupled to the support member with a C-channel conductive mechanism.

FIG. 9 is a drawing of one embodiment of the support member.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

A parent application of the present invention, U.S. Pat. No. 6,011,855 issued to Selfridge in March of 1997, along with subsequent patent applications, introduced piezoelectric film as a means for emitting parametric signals into air. The use of piezoelectric film allows production of a uniform wave front across a broad ultrasonic emitter surface. To maximize the interference between the “base signal,” or carrier wave, and the “intelligence carrying signal,” the film was formed with multiple arcuate shapes that each act as an individual emitter. The arcuate shapes were formed by disposing the film on one side of an emitter plate including a plurality of apertures, while a vacuum was placed on the opposing side of the emitter plate to pull the film against the emitter plate, thereby forming the arcuate shapes.

It has since been discovered that applying the film to the emitter plate in the pressurized state triggered by the vacuum may cause the piezoelectric film to have a variable resonance frequency depending on the pressure exerted on the film at a particular point, and may cause the emitted waves to contain unwanted distortion. Furthermore, the containment requirements of the vacuum add to the mass, volume, and manufacturing complexity of the speaker. Finally, maintaining an airtight vacuum chamber can be quite difficult.

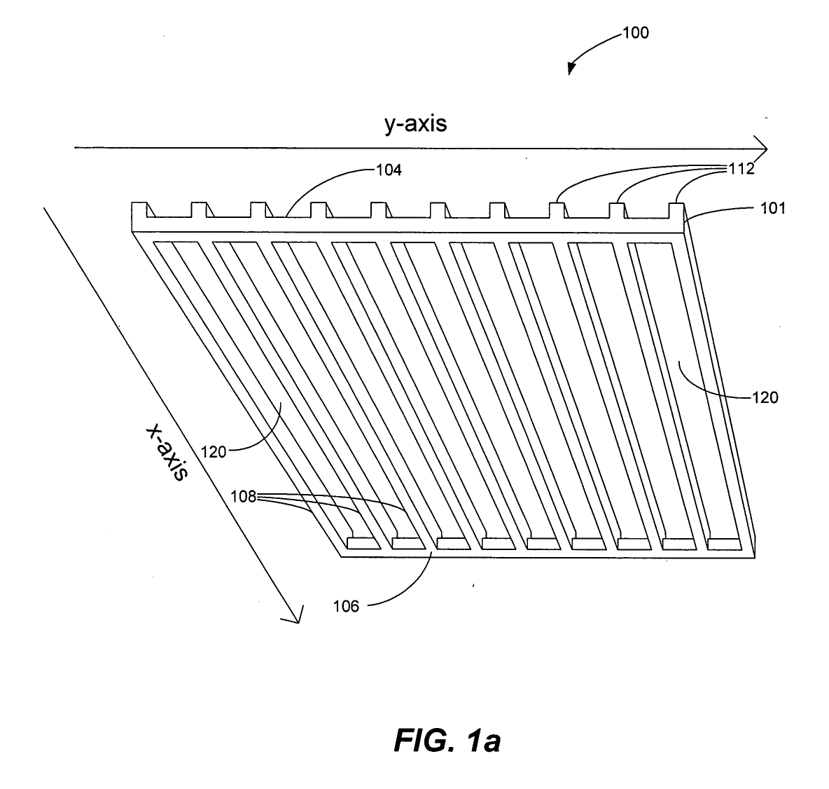

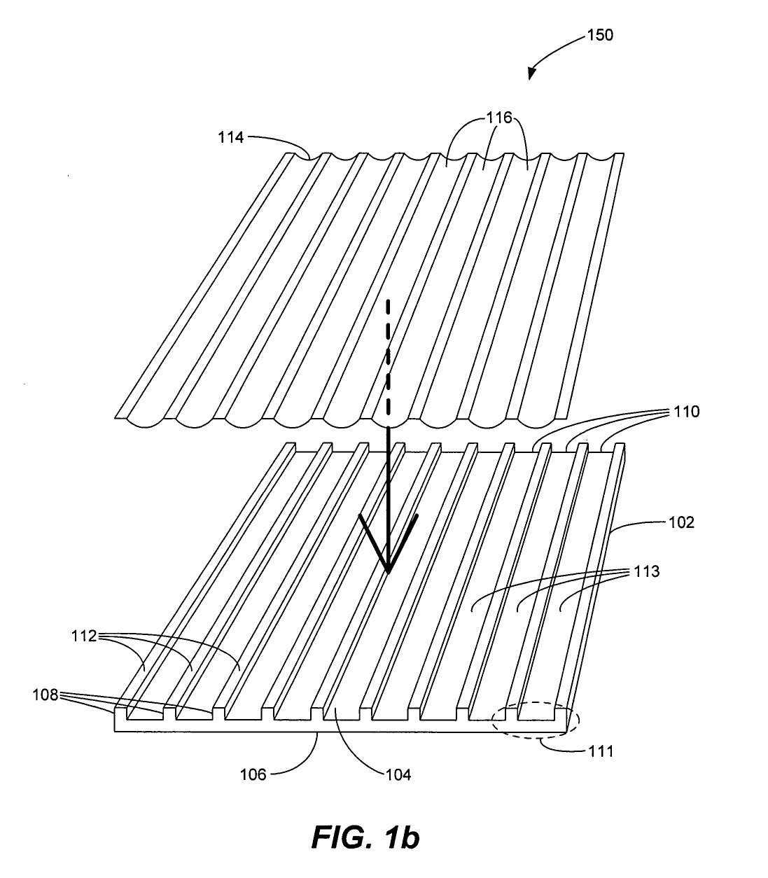

FIGS. 1a and 1b illustrate an ultrasonic parametric transducer that eliminates the need for a permanent vacuum containment. FIG. 1a is a bottom view of a support member 101 extending along an x-axis and a y-axis. The support member retains an array of parallel ridges 108 extending along the x-axis and spaced apart along the y-axis at predetermined separation distances. The ridges have forward, film contacting faces 112 to capture an emitter film in a desired film configuration for emitting parametric output. In this embodiment, the sections 120 between the ridges 108 are left open to airflow.

The transducer of FIG. 1b includes a support member 102 having opposing front 104 and back 106 surfaces, the support member extending along an x-axis and a y-axis. The support member retains an array of parallel ridges 108 extending along the x-axis and spaced apart along the y-axis at predetermined separation distances. A backplate has been formed on the back surface 106, creating an array of parallel channels 110 on the front surface, each having a channel cross section 111 and a front face 113 of predetermined depth and configuration. The ridges 108 each have a forward, film contacting face 112 positioned at a height above the support member 102. The film contacting faces 112 are configured to capture a film 114 used as an emitter at a height above the support member 102. The film has arcuate sections 116 aligned with respect to the channel cross sections of the array of parallel channels 110.

Generally, the support member may consist of any structure that retains the ridges 108 in a substantially parallel configuration. FIG. 1a illustrates a support member having two retaining crossbars extending along the y-axis. More elaborate support members may be used, comprising more or less than two retaining crossbars. An entire backplate, as shown in FIG. 1b, may be used to retain the ridges 108. Numerous variations can be made to the support member shown in FIG. 1a without deviating from the scope of the invention.

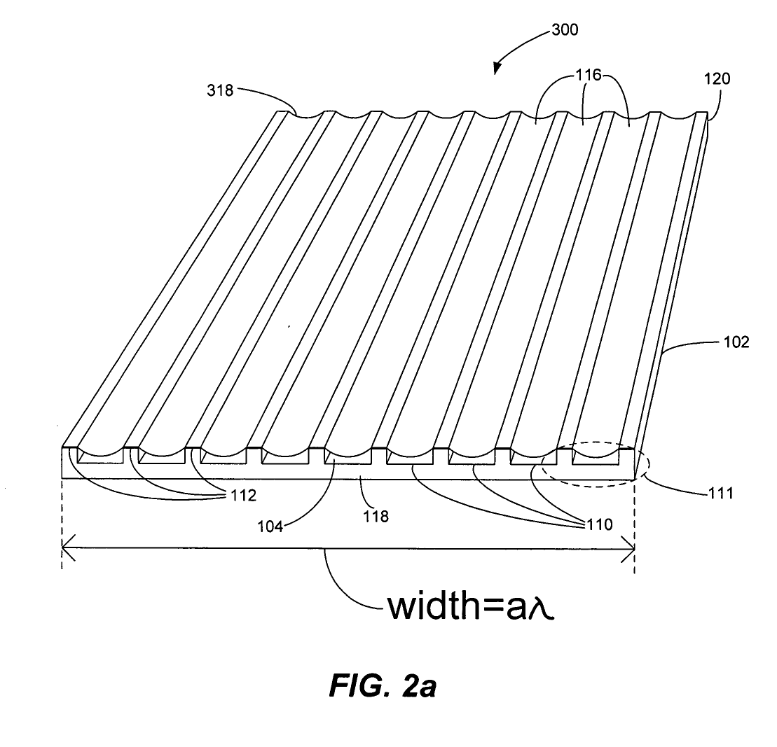

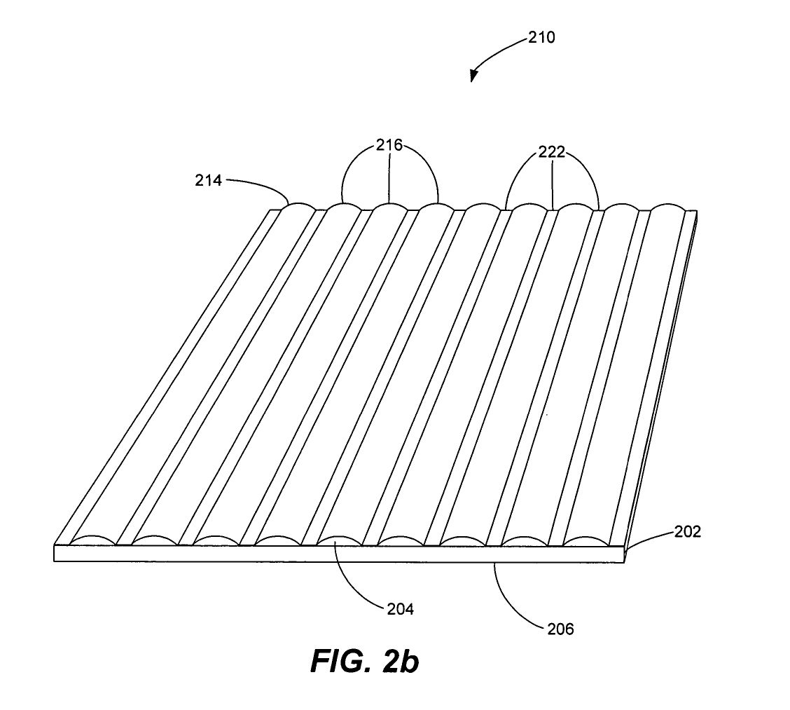

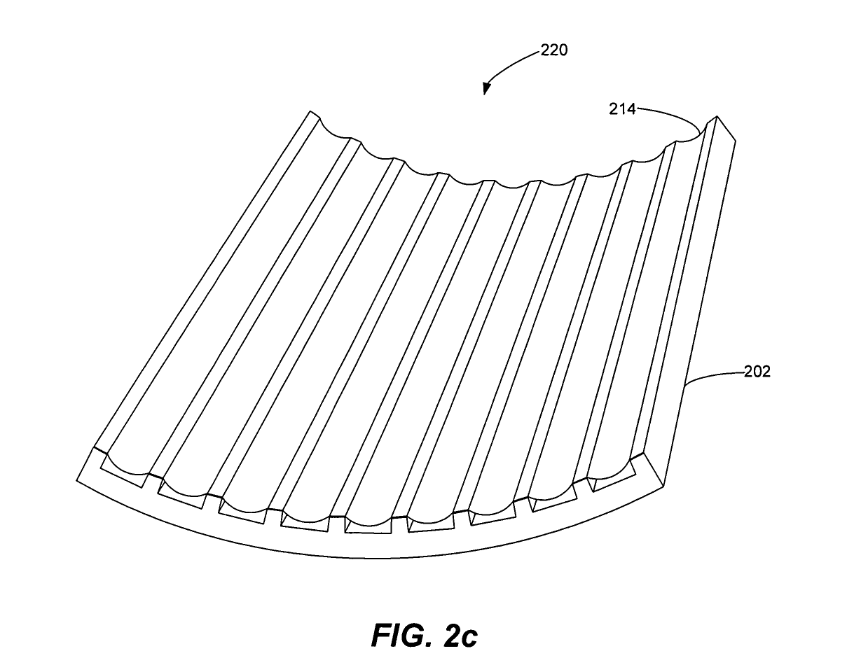

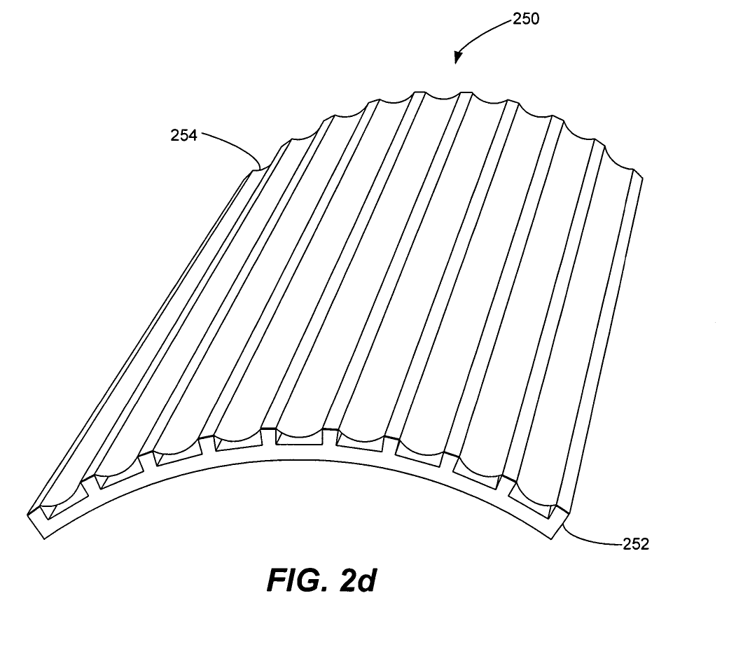

The parallel ridges may consist of any structures that provide film contacting faces 112 for capturing the film and forming intermediate arcuate sections 116 of film. The cross sections 111 and parallel channels 1 12 created by the parallel ridges need not be rectangular in shape as illustrated in FIG. 2a. Numerous modifications may be made to the parallel ridges while still providing film contacting faces as disclosed in the invention. For example, note that FIG. 2b illustrates a flat plate that includes parallel ridge locations as part of the front plate surface and provide film contacting faces.

The film contacting faces may consist of any structures that are capable of capturing the film between the arcuate sections 116 of film. The film contacting faces should be configured such that when they capture the film, each intermediate arcuate section of film 116 is substantially isolated from all other arcuate sections.

Various types of film may be used as the emitter film. The important criteria are that the film be capable of (i) deforming into arcuate emitter sections at the cavity locations or displaced positions from the support member, and (ii) responding to an applied electrical signal to constrict and extend in a manner that reproduces an acoustic output corresponding to the signal content. Although piezoelectric materials are the primary materials that supply these design elements, new polymers are being developed that are technically not piezoelectric in nature. Nevertheless, the polymers are electrically sensitive and mechanically responsive in a manner similar to the traditional piezoelectric compositions. Accordingly, it should be understood that reference to piezoelectric films in this application is intended to extend to any suitable film that is both electrically sensitive and mechanically responsive (ESMR) so that acoustic waves can be realized in the subject transducer.

As illustrated in FIG. 2a, the ESMR film 114 is applied to the support member 102 with one side of the ESMR film being captured at the film contacting faces 112, and with arcuate sections 116 aligned with respect to the channel cross sections 111 of the array of parallel channels 110.

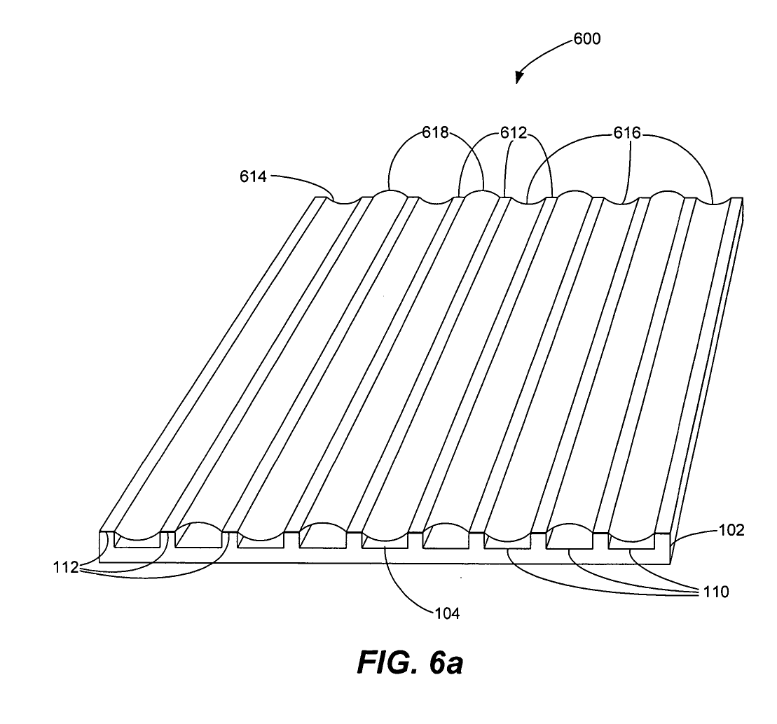

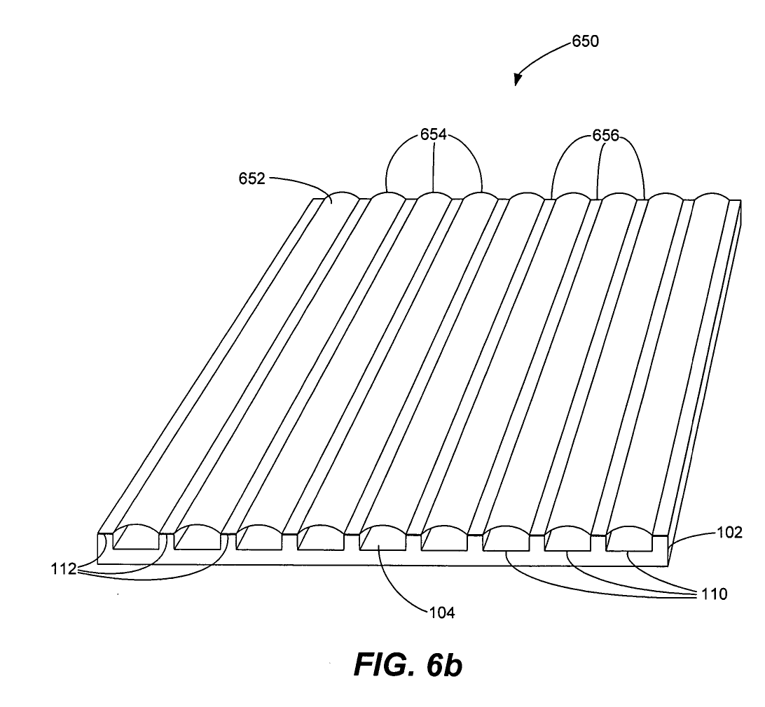

The embodiment shown in FIG. 2a has the arcuate sections applied in a concave configuration with respect to the front surface 104. The concave configuration creates a transducer that is highly robust in comparison to transducers employing convex arcuate sections (as shown in the embodiment of FIG. 6b). Because the arcuate sections are concave, the parallel ridges 108 substantially protect the film from accidental contact during use of the transducer. Another advantage of the concave configuration is that high directionality can be obtained. For example, a convex arcuate section configuration, shown in FIG. 6b, tends to disperse the propagated wave more than the concave configuration.

When the emitter film 114 is applied to the support member 102 in FIG. 1b, where a backplate has been formed on the back surface 106, the support member and the backplate may only allow an emitted wave to propagate in a forward direction. However, when the emitter film 114 is applied to the basic support member 101 in FIG. 1a, the back surface has openings 120 allowing airflow between the front 104 and back 106 surfaces. Thus, the support member may allow bidirectional propagation of emitted waves, both in a forward direction and in a rearward direction.

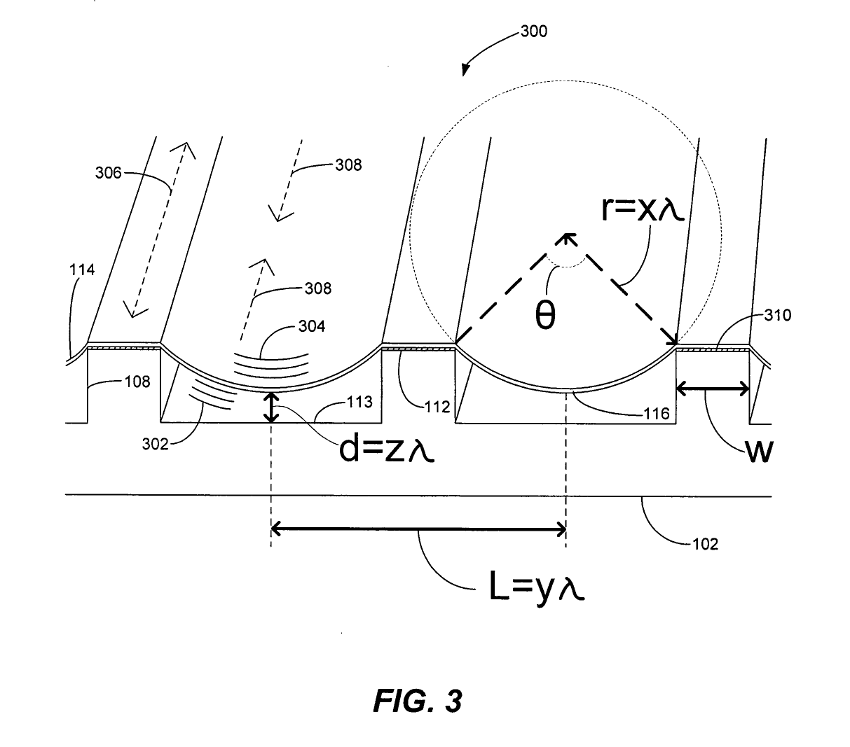

The ESMR film may be captured at the film contacting faces using an adhesive substance. The adhesive substance is denoted as 310 in FIG. 3. There may be a preference that the adhesive be electrically conductive, so that the film contacting faces 112 may also serve as electrodes to transfer a voltage applied to the support member to the ESMR film 114. When high levels of voltage are applied to an ESMR film, the film may generate heat that must be dissipated. Hence, there may be a preference that the adhesive be thermally conductive, so that the support member 102 may also serve as a heat sink for the ESMR film 114. Finally, to ease the manufacturing process, and to improve the reliability of the transducer, there also may be a preference that the adhesive have a rapid cure time, facilitated when an accelerating or activating fluid is applied. When the adhesive material is applied to the film contacting faces, it is important to apply the adhesive as uniformly as possible. Inconsistencies in the adhesives or film contacts may result in inconsistencies in the arcuate sections of the film, causing a lower Q, and unwanted distortion. A screen-printing technique may be used to uniformly apply the adhesive. It may be preferred that the thickness of the adhesive be less than ten thousandths of an inch.

FIG. 2b illustrates a transducer 210, comprised of a support member 202 having opposing front 204 and back 206 surfaces, wherein at least the front surface 204 is in a smooth continuous configuration, meaning that the support member does not have the ridges as shown in FIG. 1a. Instead, the support member includes ridge locations where the ESMR film is captured as shown at item 222. Specifically, an ESMR film 214 is disposed over the front surface 204 of the support member 202, said ESMR film being configured for emitting parametric output. The ESMR film is also configured with an array of parallel convex arcuate sections 216 alternatively separated by parallel contacting faces 222. The contacting faces are captured at the front surface 204 of the support member 202, thereby mechanically isolating each of the arcuate sections 216 of ESMR film from adjacent arcuate sections. The transducer in FIG. 2b may also include a protective cover over the ESMR film 214 to shield the convex arcuate sections from accidental contact during operation or shipping.

The transducer configuration in FIG. 2b provides the advantage of having a simple support member design. The front surface 204 of the support member 202 is smooth and continuous, without the array of ridges 108 and channels 110 as provided in the support member 102 in FIG. 1b. This simple support member design facilitates the manufacturing process of the transducer 210 because it is no longer necessary to precisely align the intermediate spacers 222 to the film contacting faces 112 shown in FIG. 1b and FIG. 2a.

FIG. 2c illustrates a variation of the transducer shown in FIG. 2a, where the support member 202 configures the ESMR film 214 to have a concave dish curvature. In this embodiment, the wave propagated from the film can be focused at a relatively small area. The transducer in FIG. 2b may also be configured in a concave dish curvature. As a further variation of FIG. 2c, the entire film can be formed as a concave bowl, allowing the propagated wave to be focused at a designated point in space.

FIG. 2d illustrates a variation of the transducer shown in FIG. 2a, where the support member 252 configures the ESMR film to have a convex dish curvature. In this embodiment, the wave propagated from the film can be dispersed over a relatively large area. The transducer in FIG. 2b may also be configured in a convex dish curvature. As a further variation of FIG. 2d, the entire film can be formed as a convex bowl, allowing the propagated wave to be dispersed to an even larger area.

Once the ESMR film is captured at the support member 102 of FIG. 2a or 202 of FIG. 2b, an electrical parametric signal may be applied to the film, causing the arcuate sections 116 to vibrate. Because areas of the ESMR film between the arcuate sections are captured at the film contacting faces 112 of FIG. 2a or at the support member 202 of FIG. 2b, the movement of each arcuate section of film 116 is substantially mechanically isolated. This mechanical isolation of the arcuate sections substantially eliminates the possibility of vibrations from one arcuate section interfering with the vibrations of another arcuate section. The width of the film contacting faces, labeled ‘w’ in FIG. 3, may be strategically established so that the film contacting faces are as small as possible, thus maximizing the area of film that is free to vibrate and maximizing the amplitude of the propagated waves, yet wide enough to mechanically isolate the movement of each arcuate section of film. By mechanically isolating the movement of the arcuate sections 116 of film, the exact curvature and radius (‘r’ in FIG. 3) of each arcuate section can be more precisely set and maintained than could be accomplished if the movement of each section of film were not mechanically isolated. By maintaining precise control over each arcuate section of film, as provided by the mechanical isolation technique of the present invention, the shape of the entire film may be highly uniform. This uniformity results in the film having a Q of at least greater than two, creating an emitted wave that is more than six dB above the reference level of the transducer. It may be preferable that a high degree of uniformity of the film be maintained, resulting in a Q much greater than two.

In one embodiment, the ESMR film may be biased into the arcuate sections at the film contacting faces without application of negative pressure to the ESMR film at the array of parallel ridges.

In one embodiment, the parallel channels 110 of support member 102 are configured to have opposing ends 118 and 120 that are maintained open to airflow to avoid pressure differentials of varying altitudes, and to provide cooling. FIG. 2a exemplifies this configuration, in that the parallel channels 110 are open to airflow. In another embodiment, the parallel channels 110 are configured to have at least one of the opposing ends 118 and 120 that is substantially blocked to airflow.

In one embodiment, the support member 202 in FIG. 2b is configured such that the convex arcuate sections of ESMR film have opposing ends that are maintained open to airflow. FIG. 2b exemplifies this configuration, in that the convex arcuate sections have opposing ends that are maintained open to airflow. In another embodiment, the support plate 202 is configured such that the convex arcuate sections of ESMR film have at least one opposing end that is maintained substantially blocked to airflow.

With the ESMR film and the support member in the configurations disclosed in the present invention, many benefits are acquired over the prior art. First, the use of an ESMR film is superior to the use of an array of hundreds or even thousands of bimorph transducers. An array of bimorph transducers requires separate wiring to drive each bimorph transducer. This adds to the complexity and cost of manufacture. Conversely, the use of an ESMR film may only necessitate one electronic coupling in order to drive the film. Furthermore, when an array of bimorph transducers is used, each transducer will likely be positioned at a slightly different angle, creating undesired phase differentials and a non-uniform wave front. Because ESMR film is a uniform, continuous surface, the waves emitted by the film are also uniform, with very little undesired phase differential.

The use of ESMR film in a substantially non-pressured state also has benefits over the prior art method of using a permanent vacuum to shape the film. A permanent vacuum will apply continuous pressure to form the film into its desired configuration. This continuous stress may stretch the ESMR film and cause the film to have a variable resonance frequency depending on the tension of the film at a particular point, and may cause the emitted waves to contain unwanted distortion. However, capturing the film in a substantially non-pressured state at a support member in accordance with the present invention avoids the use of a permanent vacuum, while maintaining the film in its desired configuration. Because the film is in a substantially non-pressured state, the frequency response of the film is more consistent, and the waves emitted from the film more closely resemble the intended waveform.

Furthermore, use of a permanent vacuum applies pressure on only one side of the film. In this condition, the vibrations of the film tend to expand further in one direction than the other. This effect can generate even-order, or asymmetric distortion in the emitted wave. Even-order distortion causes spurious even harmonics (2^{nd}, 4^{th}, 6^{th}, etc.) to be added to a signal passing through a device. Because the present invention provides a method of maintaining the arcuate sections in the film without the permanent application of a vacuum, the film is free to vibrate equally in both directions, thus substantially eliminating even-order distortion in the emitted wave.

Finally, use of a permanent vacuum requires additional structure for maintenance and the containment of the vacuum. Such a structure adds to the mass, volume, and manufacturing complexity of the speaker. The support member 102 of the present invention is much thinner than the drum or other support member previously used to provide the vacuum chamber in the prior patent application, and is also more durable.

The radius of the film's curvature and the distance between the peaks of the arcuate sections 116 of the film 114 may affect the performance of the transducer. FIG. 3 is an enlarged perspective view of two cross sections 111 from FIG. 2a. Although the transducer from FIG. 2a is employed here by way of example, the measurements disclosed hereinafter are equally applicable to all embodiments of the present invention. The variable ‘r’ represents the radius of the film's curvature, and the variable ‘L’ represents the distance between adjacent central peak depths of the arcuate sections 116 of the film. The variable λ represents the wavelength of a carrier wave frequency. The variables x, y and z represent a designated fraction of a wavelength. The resonance frequency of the film is dependant on ‘r’. As ‘r’ gets smaller, the resonance frequency of the film rises. To optimize the interaction of the parametric waves in the air so that maximum decoupling of the waves occurs, it may be beneficial to position the arcuate sections 116 such that L<½ λ.

In another embodiment of the invention, the distance ‘L’ and/or the radius ‘r’ may vary throughout the transducer structure. In order to vary the distance ‘L’, the separation distances of the parallel ridges 108 must also vary by the same amount. By varying the distance ‘L’, the radius ‘r’ of the arcuate sections 116 may also be altered. As stated above, altering ‘r’ will affect the resonance frequency of the film. Therefore, varying the radius ‘r’ and/or the distance ‘L’ will create multiple resonance frequencies, which may be desired if a wide frequency spectrum is required.

The distance from the arcuate sections 116 of the film 114 to the front face 113 of the parallel channels may also affect the performance of the transducer. In FIG. 3, the variable ‘d’ represents the distance from the central peak depth of the film's arcuate sections 116 to the front face 113 of a parallel channel 110. In one embodiment, d≦½ λ. When d=½ λ, the propagated wave that is emitted from the back of the film 302 may reflect off of the support member 102, and return out of phase with the wave emitted from the front of the film 304. Consequently, the extra sound pressure may drive the arcuate sections 116 of the film 114 out of their desired polarity, and may cause destructive interference with the wave emitted from the front of the film 304. In a preferred embodiment, where d≦¼ λ, the interference and cancellation that may occur when d=½ λ is avoided. Therefore, it may be preferred that not only the central peak of the arcuate section of the film be less than ½ λ from the front face of the parallel channel, but also that the entire length of film be less than ½ λ from the front face of the parallel channel 110.

In a preferred embodiment, the arc lengths of the arcuate sections 116 are defined by a central angle, labeled ‘θ’ in FIG. 3, of 100 degrees or less. This method of limiting the arc length provides numerous advantages over emitter films whose arc length is defined by a central angle of approximately 180 degrees (also described as a rectified sine wave form). The present invention offers lower distortion, a smoother frequency response, and fewer spurious resonant frequencies than the rectified sine form. Furthermore, because the arcuate sections of the present invention are usually smaller than the rectified sine form, the present invention is more robust and reliable.

It may also be preferred that the width of the film emitter, labeled ‘width’ in FIG. 2a, be at least approximately five wavelengths of a carrier wave frequency to be propagated from the transducer. It may also be preferred that the width of ESMR film emitters, labeled ‘width’ in FIG. 3, be significantly greater than five wavelengths of a carrier wave frequency to be propagated from the transducer. For example, the present inventors have further discovered that these procedures surprisingly enable implementation of larger emitters having dimensions of 10 wave lengths or more, including monolithic film emitters as disclosed herein. Such large dimensions can be in either the x or y direction, or both. For nonparametric applications, the choice of wave lengths would be based on the primary or dominant operating frequencies of the speaker.

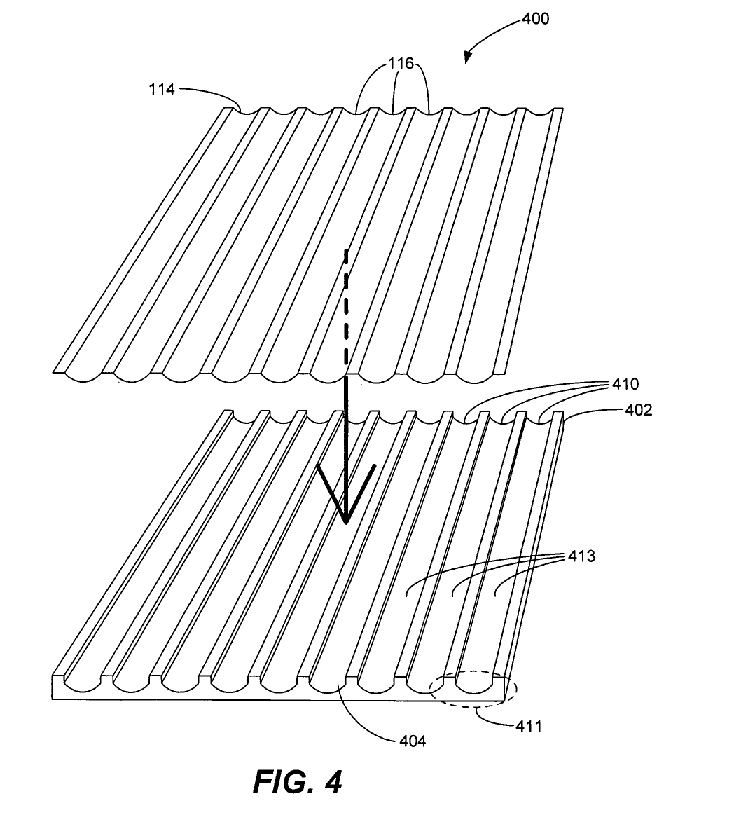

In order to obtain a more constant distance between the film and the front face of the parallel channels, FIG. 4 portrays an embodiment of the invention 400 where the cross sections 411 of the parallel channels 410 are configured with a curvature approximately corresponding to the arcuate sections 116 of the film 114 extending into the channel cross sections 411. Instead of being flat, as are the parallel channels 110 in FIG. 1, the parallel channels 410 in FIG. 4 are concave with respect to the front surface 404 of the support member 402. In this configuration, the film 114 may be positioned at a distance of approximately ¼ λ from the front faces 413 of the parallel channels 410 throughout the width of each parallel channel instead of only at a central peak depth of the film's arcuate sections.

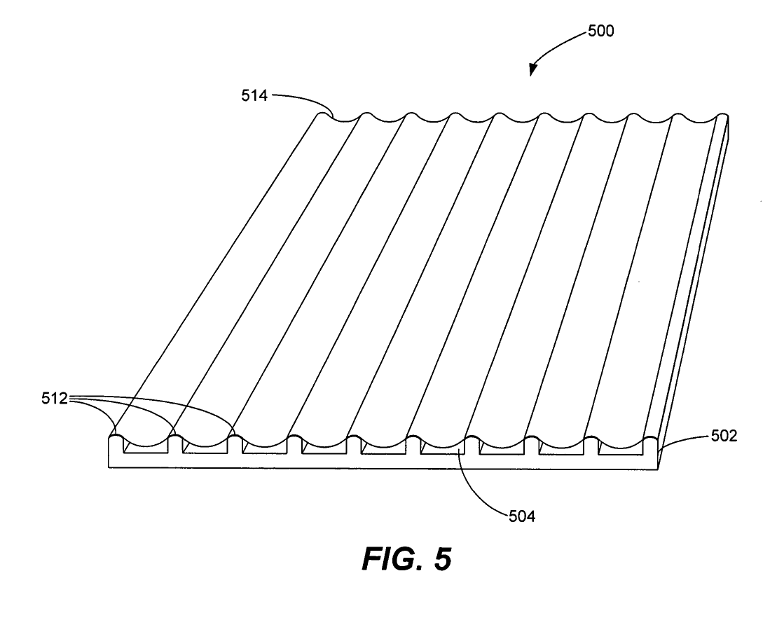

In another embodiment of the invention, shown in FIG. 5, the film contacting faces 512 are structured to include a convex curvature with respect to the front surface 504 of the support member 502. Consequently, the ESMR film 514 is formed on the support member 502 without any abrupt edges. The smoothness of the film provides a uniform surface wherefrom parametric signals are propagated.

The concepts from FIGS. 4 and 5 may be combined, such that the support member includes parallel channels 410 having a concave curvature with respect to the front surface of the support member and film contacting faces 512 having a convex curvature with respect to the front surface of the support member. Thus, the transducer will have the benefits of maintaining the film at a nearly constant distance from the parallel channels of the support member, and of providing a uniform surface.

As illustrated in FIG. 6a, the ESMR film 614 may be configured to alternate between a concave arcuate section 616 and a convex arcuate section 618. The concave and convex arcuate sections are separated by contacting sections 612 corresponding to the film contacting faces 112 of the support member 102. When the contacting sections 612 are captured by the film contacting faces, each arcuate section of film is isolated from adjacent arcuate sections. This embodiment of the invention may help to avoid even-order distortion in the emitted wave. This embodiment is unique over a continuous sine wave shape, without the contacting sections 612 separating the concave 616 and convex 618 arcuate sections. The continuous sine wave shaped film can produce multiple sidelobe waves (waves that propagate in a direction other than the main column of sound). Thus, the high-directionality normally provided by parametric loudspeakers can be substantially lost. When the contacting sections 612 are captured at the film contacting faces 112, the movement of each of the arcuate sections 616 and 618 is isolated. This isolation substantially eliminates the propensity for sidelobes in the propagated wave.

As illustrated in FIG. 6b, the film may be configured such that the arcuate sections 554 of the film 552 extend away from the channel cross sections of the array of parallel channels 110, where the arcuate sections would be convex with respect to the front surface 104 of the support member 102. This embodiment may cause the waves propagated from the film 552 to disperse more than the embodiment shown in FIG. 2b, where the arcuate sections extend into the channel cross sections. Because the arcuate sections extend away from the support member 102, the film 552 is prone to accidental bumps during use, causing the film to be susceptible to dents, thus impairing the film's ability to generate pure output. In the embodiment shown in FIG. 2a, where the arcuate sections are concave with respect to the front surface, the film is much more protected from accidental bumps during use.

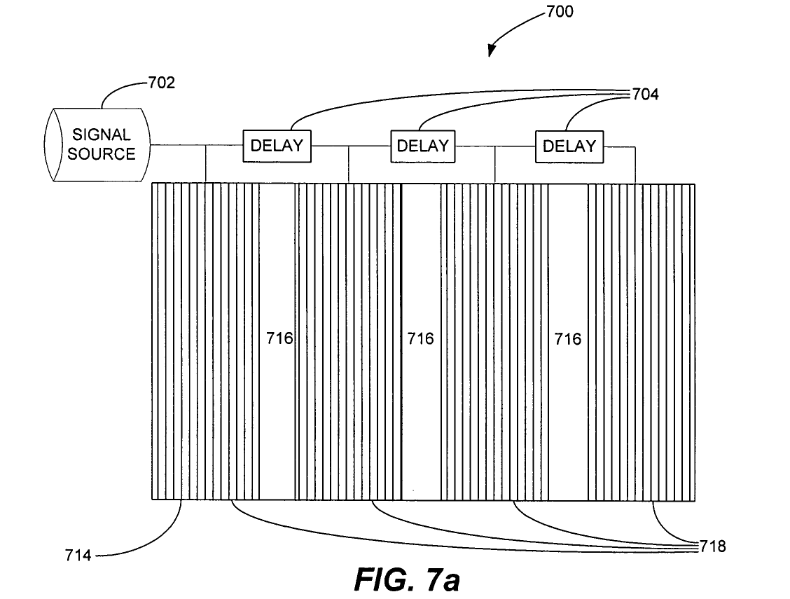

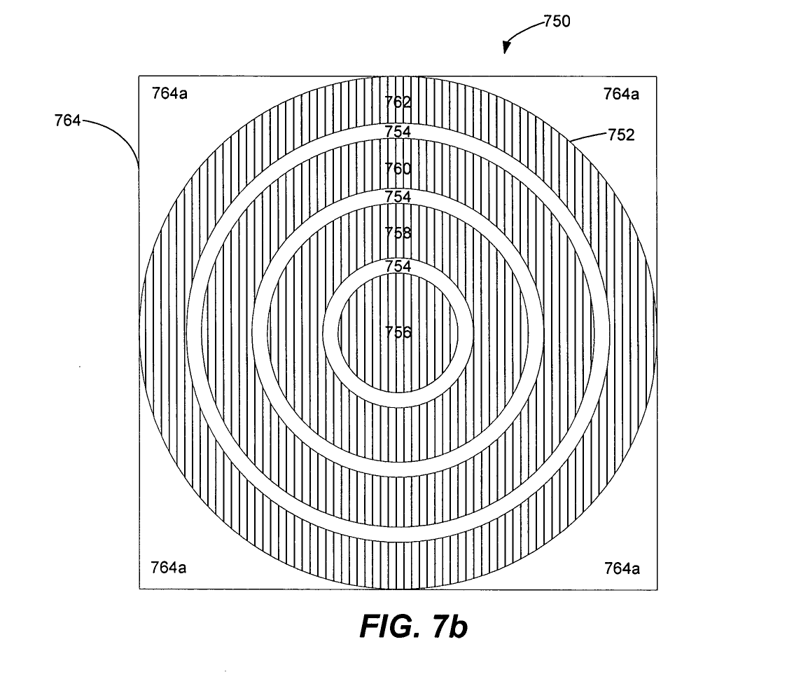

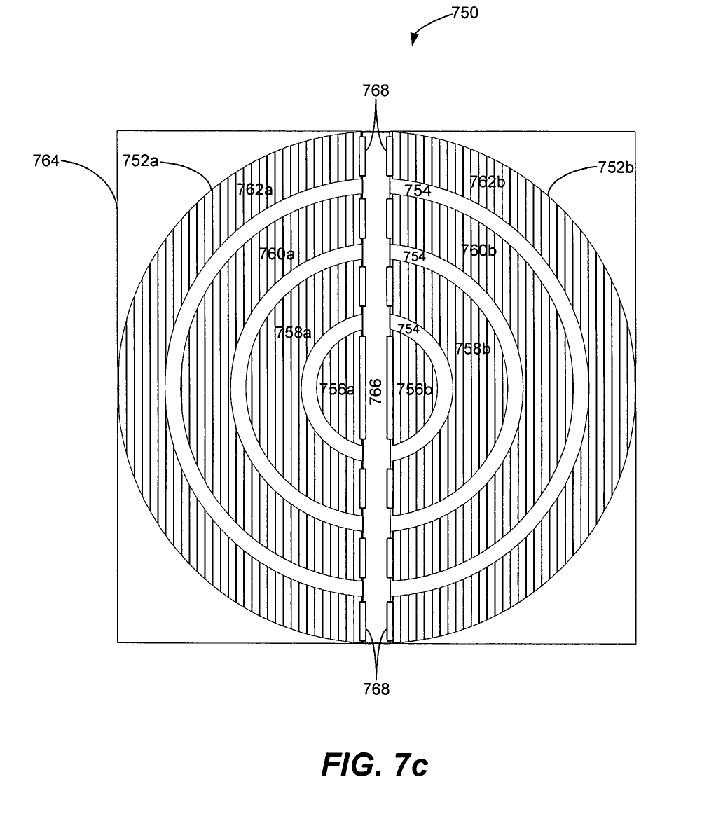

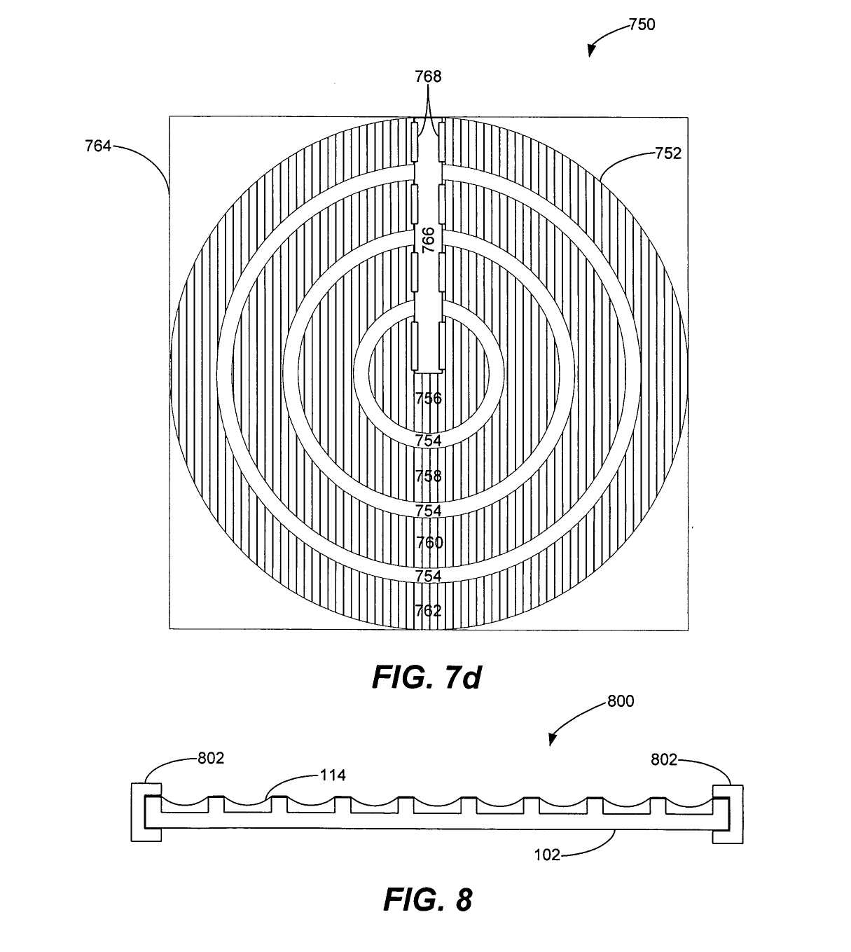

In another embodiment of the invention, shown in FIG. 7a, the transducer is configured such that phase controlling of the propagated wave at the emission surface may be performed. The film 714 is divided into multiple electrically isolated conductive portions 718 by etching away separating strips 716. Preferably, only the conductive portion of the separating strips 716 has been etched away, so that the emitter film 714 is still one continuous, uniform piece of film. Each of the electrically isolated portions of film may be driven by a unique parametric signal. The unique parametric signals may be produced by a delay line 704, which is electronically coupled to a signal source 702. The delay line is comprised of a plurality of delay circuits, wherein each delay circuit is electronically coupled to one of the separate pieces of film. The delay circuits may be either active or passive delays. By phase delaying the parametric signal applied to one piece of film more than the parametric signals applied to other pieces of film, a phase differential between the pieces of film is created, and the sound beam can be guided in different directions by optimizing the phase relationship between the different electrically isolated portions of film to maximum amplitude summation in a predetermined direction or point in space by achieving the minimum phase differential from the film regions in that predetermined direction or point in space. While FIG. 7a only shows a one-by-four array of electrically isolated conductive portions, more complex arrays can be formed that allow precise phase control of the propagated wave at the emission surface, thus allowing for precise directivity of the wave front. The delay circuits may also be switchable so that the delay can be turned off, creating an emitter surface that does not control phase of the propagated wave at the emission surface. Alternatively, instead of delay circuits, the electrically isolated conductive portions of film may be sized and wired in or out of phase in relationships that can minimize the phase differential and maximize the parametric output in the preferred direction.

In another embodiment for phase controlling of the propagated wave at the emission surface, FIG. 7b illustrates a transducer 750 where at least one ring section 754 of the electrically conductive portion of the ESMR film is etched away on at least a front or a back side surface, or both sides. The etching forms at least a center circular conductive portion of film 756, and at least one outer ring portion of conductive film 758, 760, and 762. Each conductive portion of film 756, 758, 760, and 762 is electrically isolated. The etched ring portions of film 754 are formed as narrow as possible while avoiding electrical arcing between the conductive portions of film 756, 758, 760, and 762. The width of the etched portions 754 may be one-sixteenth of an inch. The phases of the isolated conductive portions 756 and 760 may be set to zero degrees, and the phases of the parametric signals driving the isolated conductive portions 758 and 762 may be shifted by 180 degrees. Thus, the sound beam propagated from the film can be manipulated to converge to a specific point in space.

In another embodiment of FIG. 7b, the conductive portions 758, 760, and 762 may be sized and phased such that their propagated waves will arrive at a designated point in space preferably within a ±90 degree phase change and for a an even more efficient result a ±45 degree phase differential at the designated point in space or less may be employed. The central conductive portion 756 may be sized such that its propagated wave will arrive at the same designated point in space within a ±90 degree phase change. The diameters of each conductive ring portion of film will depend on the carrier wave frequency and the distance of the desired focal point from a front surface of the transducer.

While FIG. 7b shows only four conductive portions of film, the film may be divided into any number of conductive portions. The delay circuits used to create the phase differentials may be switchable so that the delay can be turned off, creating an emitter surface that does not modify the phase of the propagated wave at the emission surface.

The ESMR film 752 may be placed on any support member 764, including but not limited to the support members disclosed in the present invention. Because the support members disclosed in the invention may be square or rectangular in shape, the corners of the support member 764a may not conform to the ring configuration of the conductive portions of film. Therefore, the corners 764a may be left bare (without film) as shown in FIG. 7b. Alternatively, the conductive ring portions of film may extend throughout the corners, but will not be continuous through the side portions of the support member. Extending the conductive ring portions throughout the corners of the support member provides a greater film surface area, thereby generating propagated waves with increased amplitudes.

Various techniques of creating electrical contacts to the conductive portions of film may be employed. One technique, illustrated in FIG. 7c is to divide the entire piece of film in half, separating the film into two pieces 752a and 752b. By separating the film, electrical contacts 768 can be placed on the inner edges of the conductive portions of film. The electrical contacts 768 may be secured in place by a thin circuit board 766 extending the entire diameter of the ESMR film. The circuit board 766 may also contain the delay line discussed previously, and supply the electronic signals to the electronic contacts 768 or may merely be a routing means to connect a desired amplifier output polarity or phase to each ring.

Another technique of creating electrical contacts to the conductive portions of film, illustrated in FIG. 7d, is to slice away one section of film. Electrical contacts 768 can then be placed on the inner edges of the conductive portions of film. The electrical contacts 768 may be secured in place by a thin circuit board 766 extending through the portion of ESMR film that has been sliced away. The circuit board 766 may also contain the delay line discussed previously, and supply the electronic signals to the electronic contacts 768 or may merely be a routing means to connect a desired amplifier output polarity or phase to each ring.

An example of a focusing parametric transducer as described in FIGS. 7b, 7c, and 7d will now be provided. This example transducer is designed to create a focal point at 36 inches from the front surface of the transducer, using a carrier frequency of 46 kHz. The ESMR film is mounted on a 14″ square support member. The conductive ring portions each have a radius of 2.3″ (inner circle), 4″, 5.16″, 6.1″, 6.9″, and 7.68″ (extending into the corners of the support member, and being cut off on the edges). To achieve maximum output and focus at the 36 inch distance the rings are phased such that the center portion as section one and each odd numbered section/ring are at zero phase reference and each even ordered section/ring is operated 180 degrees out of phase compared to the zero phase reference. This may be made to be switch-able such that all section/rings can operate in-phase forming a normal parametric column.

In accordance with FIG. 8, the transducer may also include one or more C-channel mechanisms 802 to couple the ESMR film 114 to the edges of the support member 102. The C-channel may be composed of a conductive material, and provides a relatively large electrical coupling area between the C-channel and the film as compared to point contacts of electrical coupling.

In addition to electronically coupling the edges of the film to the signal source using the C-channels, the film may be electronically coupled to the signal source in various positions throughout the center of the film. When using large pieces of ESMR film, and when coupling the signal source to the edges of the film, the resistive losses of the film's metallization may attenuate the signal near the center of the film. By electronically coupling the film to the signal source in various positions throughout the center of the film, the signal strength remains substantially consistent throughout the film. One method of electronically coupling the center of the film to the signal source is by applying the signal source to one or more conductive film contacting faces, which are electronically coupled to the corresponding captured portions of film.

In the above cases, the separate conductive regions of the film diaphragm may be isolated on both the front and back surface sides of the film or may be only isolated from each other on one surface side, with the remaining surface side of the film being conductively continuous across that surface side. In the later case, the continuous side may be driven from a common ground potential of an amplifier system with alternate polarity, phases or delays driving the isolated regions on the opposite surface side.

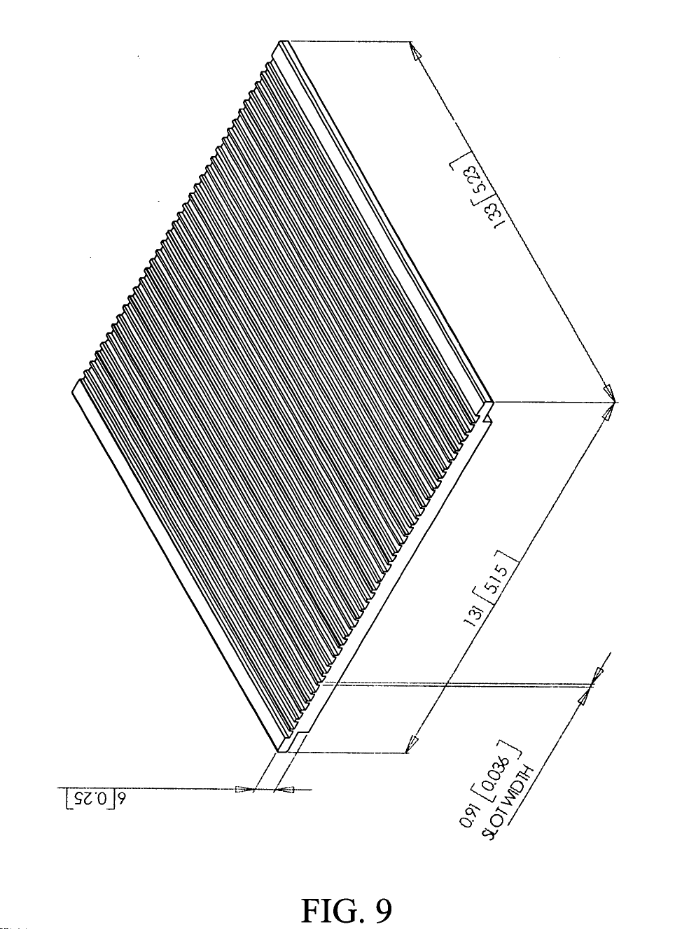

FIG. 9 is a drawing of one embodiment of the support member. The support member has a width along the y-axis of 131 millimeters, or 5.15 inches. The support member has a length along the x-axis of 133 millimeters, or 5.23 inches. The height of the support member is 6 millimeters, or 0.24 inches. The width of each film contacting face, labeled “slot width” in FIG. 9 and ‘w’ in FIG. 3, is 0.91 millimeters, or 0.036 inches. As illustrated in the above embodiment, the present invention realizes an effective parametric ultrasonic loudspeaker in a very simple, compact device.

It is to be understood that the above-referenced arrangements are illustrative of the application for the principles of the present invention. Numerous modifications and alternative arrangements can be devised without departing from the spirit and scope of the present invention while the present invention has been shown in the drawings and described above in connection with the exemplary embodiments(s) of the invention. It will be apparent to those of ordinary skill in the art that numerous modifications can be made without departing from the principles and concepts of the invention as set forth in the examples.

1. A parametric transducer, comprising:
(a) a support member extending along an x-axis and a y-axis and having opposing front and back surfaces, the support member including an array of parallel ridge locations extending along the x-axis and spaced apart along the y-axis at predetermined separation distances; said ridge locations having forward, film contacting faces to support an emitter film in a desired film configuration for emitting parametric output; and
(b) an electrically sensitive and mechanically responsive (ESMR) film disposed over the support member with one side of the ESMR film being captured by the film contacting faces, and with arcuate sections aligned with and positioned between the parallel ridge locations, said film contacting faces mechanically isolating each of the arcuate sections of ESMR film from adjacent arcuate sections.

2. A transducer as defined in claim 1, wherein the arcuate sections of the ESMR film are concave with respect to the front surface.

3. A transducer as defined in claim 1, wherein the arcuate sections of the ESMR film are convex with respect to the front surface.

4. A transducer as defined in claim 1, further comprising a backplate on the back surface of the support member, thereby creating an array of parallel channels on the front surface, each channel having a channel cross section and a front face of a predetermined depth and configuration.

5. A transducer as defined in claim 4, wherein the channel cross section includes a curvature approximately corresponding to the arcuate sections of the ESMR film extending into the channel cross sections.

6. A transducer as defined in claim 5, wherein the height of the film contacting faces is established such that the arcuate sections of the ESMR film each have a separation distance from the front face of the parallel channels of no greater than approximately one-quarter wavelength of a carrier wave frequency to be propagated from the transducer.

7. A transducer as defined in claim 4, wherein the height of the film contacting faces is established such that the arcuate sections of the ESMR film each have a separation distance from the front face of the parallel channels of less than approximately one-half wavelength of a carrier wave frequency to be propagated from the transducer.

8. A transducer as defined in claim 7, wherein the height of the film contacting faces is established such that the arcuate sections of the ESMR film have a separation distance from a front facing panel of the parallel channels of no greater than approximately one-quarter wavelength of the carrier wave frequency to be propagated from the transducer.

9. A transducer as defined in claim 7, wherein the height of the film contacting faces is established such that at least central peak depths of the arcuate sections of the ESMR film have a separation distance from the front face of the parallel channels of no greater than approximately one-quarter wavelength of the carrier wave frequency to be propagated from the transducer.

10. A transducer as defined in claim 1, wherein the ESMR film is biased into the arcuate sections at the film contacting faces without application of negative pressure to the ESMR film.

11. A transducer as defined in claim 1, wherein the parallel ridge locations comprise raised ridges and are configured to have opposing ends that are maintained open to airflow.

12. A transducer as defined in claim 1, wherein the parallel ridge locations comprise raised ridges and are configured to have opposing ends that are substantially blocked to airflow.

13. A transducer as defined in claim 1, wherein at least one section of at least one surface side of an electrically conductive portion of the ESMR film is etched away, thereby forming at least two electrically isolated conductive portions of the film on at least one surface side of the film.
a. A transducer as defined in claim 13, further including being driven by signals of more than one phase, wherein at least two opposite phase signals are used to drive the electrically isolated conductive portions of the film.

14. A transducer as defined in claim 13, further including a passive delay line comprised of a plurality of delay circuits, wherein each delay circuit is electronically coupled to one of the electrically isolated conductive portions of the ESMR film, wherein the passive delay line produces multiple parametric signals that drive the electrically isolated conductive portions of the ESMR film, wherein at least one of the parametric signals are delayed to establish a phase differential.

15. A transducer as defined in claim 14, more specifically including at least one ring section of the electrically conductive portion of the ESMR film is etched away, thereby forming at least a center circular conductive portion of the film, and at least one outer ring conductive portion of the film, wherein each of the conductive portions of the film are electrically isolated.

16. A transducer as defined in claim 1, wherein the ESMR film alternates between a concave arcuate section and a convex arcuate section alternatively separated by contacting sections, wherein the contacting sections are captured at the film contacting faces of the support member, said film contacting faces mechanically isolating each of the arcuate sections of ESMR film from adjacent arcuate sections.

17. A transducer as defined in claim 1, further comprising an adhesive material to capture the ESMR film to the film contacting faces.

18. A transducer as defined in claim 17, wherein the adhesive material is a thermally conductive adhesive.

19. A transducer as defined in claim 17, wherein the adhesive material is an electrically conductive adhesive.

20. A transducer as defined in claim 17 wherein the adhesive material on the film contacting faces has a thickness of less than approximately ten thousandths of an inch.

21. A transducer as defined in claim 1, wherein the film contacting faces include a convex curvature with respect to the front surface.

22. A transducer as defined in claim 1, further comprising a C-channel conductive mechanism to couple the support member to edges of the ESMR film, providing a relatively large electrical coupling area between the C-channel and the ESMR film as compared to point contacts of electrical coupling.

23. A transducer as defined in claim 1, wherein central peak depths of the arcuate sections include a separation distance from one another of no further than one-half wavelength of a carrier wave frequency to be propagated from the transducer.

24. A transducer as defined in claim 1, wherein the predetermined separation distances of the parallel ridge locations include at least two different distances.

25. A transducer as defined in claim 1, wherein the arcuate sections of the ESMR film include at least two different radii.

26. A transducer as defined in claim 1, wherein the ESMR film is thermal formed to the arcuate sections prior to capturing the film to the film contacting faces.

27. A transducer as defined in claim 1, wherein the support member is configured to allow bidirectional propagation of emitted waves from the ESMR film, both in a forward and a rearward direction.

28. A transducer as defined in claim 1, wherein the ESMR film has at least one dimension of at least approximately ten wavelengths of a dominant or carrier wave frequency to be propagated from the transducer.

29. A transducer as defined in claim 1, wherein the ESMR film has at least one dimension of at least approximately five wavelengths of a dominant or carrier wave frequency to be propagated from the transducer.

30. A transducer as defined in claim 1, wherein arc lengths of the arcuate sections are defined by a central angle of no greater than approximately 100 degrees.

31. A transducer as defined in claim 1, wherein the support member and ridge locations configure the ESMR film to have a concave dish curvature for focusing a propagated wave.

32. A transducer as defined in claim 1, wherein the support member and ridge locations configure the ESMR film to have a convex dish curvature for dispersing a propagated wave.

33. A transducer as defined in claim 1, where the ridge locations are contacting faces at a flat plate positioned to capture contacting faces of the ESMR film.

34. A parametric transducer, comprised of:
(a) a support member having opposing front and back surfaces, wherein at least the front surface is in a smooth continuous configuration; and
(b) an electrically sensitive and mechanically responsive (ESMR) film disposed over the front surface of the support member, said ESMR film configured for emitting parametric output and with an array of parallel convex arcuate sections alternatively separated by parallel contacting faces, wherein the parallel contacting faces of the ESMR film are captured at the front surface of the support member, thereby mechanically isolating each of the arcuate sections of ESMR film from adjacent arcuate sections.

35. A transducer as defined in claim 34, wherein a radius of the convex arcuate sections are established such that at least central peak depths of the arcuate sections of the ESMR film have a separation distance from the front face of the parallel channels of no greater than approximately one-quarter wavelength of the carrier wave frequency to be propagated from the transducer.

36. A transducer as defined in claim 34, wherein a radius of the convex arcuate sections is established such that at least central peak depths of the arcuate sections of the ESMR film have a separation distance from the front face of the parallel channels of no greater than approximately one-half wavelength of the carrier wave frequency to be propagated from the transducer.

37. A transducer as defined in claim 34, wherein the support member is configured such that the convex arcuate sections of ESMR film have opposing ends that are maintained open to airflow.

38. A transducer as defined in claim 34, wherein the support member is configured such that the convex arcuate sections of ESMR film have at least one opposing end that is maintained substantially blocked to airflow.

39. A transducer as defined in claim 34, wherein at least one section of an electrically conductive portion of the ESMR film is etched away, thereby forming at least two electrically isolated conductive portions of the ESMR film.

40. A transducer as defined in claim 39, further including a passive delay line comprised of a plurality of delay circuits, wherein each delay circuit is electronically coupled to one of the electrically isolated conductive portions of the ESMR film, wherein the passive delay line produces multiple parametric signals that drive the electrically isolated conductive portions of the ESMR film, wherein at least one of the parametric signals is delayed to establish a phase differential.

41. A transducer as defined in claim 40, more specifically including at least one ring section of the electrically conductive portion of the ESMR film which is etched away, thereby forming at least a center circular conductive portion of the film, and at least one outer ring conductive portion of the film, wherein each of the conductive portions of the film is electrically isolated.

42. A transducer as defined in claim 34, further comprising an adhesive material to capture the ESMR film to the film contacting faces.

43. A transducer as defined in claim 42, wherein the adhesive material is a thermally conductive adhesive.

44. A transducer as defined in claim 42, wherein the adhesive material is an electrically conductive adhesive.

45. A transducer as defined in claim 42, wherein the adhesive material on the film contacting faces has a thickness of less than approximately ten thousandths of an inch.

46. A transducer as defined in claim 34, further comprising a C-channel conductive mechanism to couple the support member to edges of the ESMR film, providing a relatively large electrical coupling area between the C-channel and the ESMR film as compared to point contacts of electrical coupling.

47. A transducer as defined in claim 34, wherein central peak depths of the arcuate sections include a separation distance from one another of no further than one-half wavelength of a carrier wave frequency to be propagated from the transducer.

48. A transducer as defined in claim 34, wherein the arcuate sections of the ESMR film include at least two different radii.

49. A transducer as defined in claim 34, wherein the arcuate sections of the ESMR film are thermal formed prior to capturing the film at the film contacting faces.

50. A transducer as defined in claim 34, wherein the ESMR film has a width along the y-axis of at least approximately five wavelengths of a carrier wave frequency to be propagated from the transducer.

51. A transducer as defined in claim 34, wherein arc lengths of the arcuate sections are defined by a central angle of no greater than approximately 100 degrees.

52. A transducer as defined in claim 34, wherein the support member and the ESMR film have a concave dish curvature for focusing a propagated wave.

53. A transducer as defined in claim 34, wherein the support member and the ESMR film have a convex dish curvature for dispersing a propagated wave.
